(19) United States
(12) Patent Application Publication
(10) Pub. No.: US 2010/0141613 A1
(43) Pub. Date: Jun. 10, 2010

(54) Electronic Device and Display Control Method

(75) Inventor: Hajime Sonobe, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/538,654

(22) Filed: Aug. 10, 2009

(30) Foreign Application Priority Data
Dec. 10, 2008 (JP) 2008-315068

(51) Int. Cl. G09G 5/00

(52) U.S. Cl. 345/204

(57) ABSTRACT

According to one embodiment, an electronic device includes wireless communication modules, a storage module, a communication module, a frequency specifying module, and a controller. The wireless communication modules use different communication frequency bands. The storage module stores operation frequencies to control display of a display module and setting information. Each of the operation frequencies is associated with a piece of the setting information to control the display of the display module based on the operation frequency. The communication module specifying module specifies a wireless communication module that is performing communication. The frequency specifying module specifies, from the operation frequencies stored in the storage module, an operation frequency no integer multiple of which is included in the communication frequency band of the specified wireless communication module. The controller controls the display of the display module based on a piece of the setting information associated with the specified operation frequency.

### CROSS-REFERENCE TO RELATED APPLICATIONS

This application is based upon and claims the benefit of priority from Japanese Patent Application No. 2008-315068, filed Dec. 10, 2008, the entire contents of which are incorporated herein by reference.

### BACKGROUND

1. Field

One embodiment of the invention relates to an electronic device that performs display control during wireless communication and a display control method.

2. Description of the Related Art

Commonly used computers including notebook personal computers (PCs) are connected to an external network to perform data communication.

Since the notebook PCs are portable, they can be used in diverse locations and environments. On such an occasion, it is troublesome to connect a notebook PC to a wired network, and therefore, it is highly likely to use a wireless network. However, available wireless communication standards may vary depending on locations. Because of this, to enable communication in various places, it is often the case that the notebook PCs are provided with a plurality of types of wireless modules.

This causes interference especially between the operation frequency band of devices in the notebook PCs and the wireless communication frequency band, resulting in a situation where it is difficult to establish a wireless communication connection. In view of this, there have been proposed some technologies for preventing frequency interference between the wireless modules and other electronic devices.

For example, Japanese Patent Application Publication (KOKAI) No. 2002-290261 discloses a conventional technology in which, assuming that a notebook PC is provided with a plurality of wireless modules, the operation frequency band of the CPU is changed so that it does not interfere with the wireless communication frequency band. Since the operation frequency band of the CPU is changed and does not interfere with the wireless communication frequency band, wireless communication can be performed.

An electronic device such as a notebook PC, however, is provided with, in addition to the CPU, various other devices that outputs a frequency. Example of such devices include an LCD panel (a display device). Because of a limit on parameters such as resolution and horizontal frequency for controlling the display of the LCD panel (a display device), the above conventional technology is not applicable.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a notebook PC according to an embodiment of the invention;

FIG. 2 is an exemplary block diagram of a hardware configuration of the notebook PC in the embodiment;

FIG. 3 is an exemplary schematic diagram of a frequency band management table that stores a communication frequency band for a first wireless module and a second wireless module in the embodiment;

FIG. 4 is an exemplary block diagram of a software configuration of the notebook PC in the embodiment;

FIG. 5 is an exemplary schematic diagram of the table structure of a communication frequency information table in the embodiment;

FIG. 6 is an exemplary schematic diagram, of display timing information to display resolution in WXGA in the embodiment;

FIG. 7 is another exemplary schematic diagram of display timing information to display resolution in WXGA in the embodiment;

FIG. 8 is an exemplary conceptual diagram for explaining the relationship between an LCD panel, and active periods and blanking periods in the embodiment;

FIGS. 9A and 9B are exemplary conceptual diagrams for explaining the adjustment of a horizontal blanking period in the embodiment; and

FIG. 10 is an exemplary flowchart of the process of controlling display on the LCD panel of the notebook PC in the embodiment.

### DETAILED DESCRIPTION

Various embodiments according to the invention will be described hereinafter with reference to the accompanying drawings. In general, according to one embodiment of the invention, an electronic device comprises a plurality of wireless communication modules, a storage module, a communication module specifying module, a frequency specifying module, and a controller. The wireless communication modules is configured to use different communication frequency bands. The storage module is configured to store operation frequencies to control display of a display module and pieces of setting information. Each of the operation frequencies is associated with a piece of the setting information to control the display of the display module based on the operation frequency. The communication module specifying module is configured to specify, from the wireless communication modules, a wireless communication module that is performing communication. The frequency specifying module is configured to specify, from the operation frequencies stored in the storage module, an operation frequency no integer multiple of which is included in the communication frequency band of the wireless communication module specified by the communication module specifying module. The controller is configured to control the display of the display module based on a piece of the setting information associated with the operation frequency specified by the frequency specifying module.

According to another embodiment of the invention, there is provided a display control method applied to an electronic device comprising a storage module configured to store operation frequencies to control display of a display module and pieces of setting information. Each of the operation frequencies is associated with a piece of the setting information to control the display of the display module based on the operation frequency. The display control method comprising: a communication module specifying module specifying, from a plurality of wireless communication modules configured to use different communication frequency bands, a wireless communication module that is performing communication; a frequency specifying module specifying, from the operation frequencies stored in the storage module, an operation frequency no integer multiple of which is included in the communication frequency band of the wireless communication module specified by the communication module specifying module; and a controller controlling the display of the display module based on a piece of the setting information associated with the operation frequency specified by the frequency specifying module.

While the electronic device of the embodiments is described below as a notebook personal computer (PC), it is not limited to a notebook PC, but may be any other device.

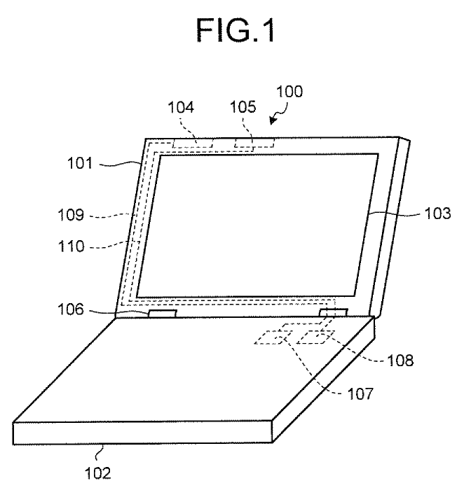

FIG. 1 is a perspective view of a notebook PC 100 according to an embodiment of the invention. As illustrated in FIG. 1, the notebook PC 100 comprises a display module 101 and a main body 102. The display module 101 comprises a liquid crystal display (LCD) panel 103 subjected to display control. The display module 101 further comprises a first wireless communication antenna 104 and a second wireless communication antenna 105 above the LCD panel 103. The display module 101 is rotatably supported on the main body 102 by hinges 106 so that it can rotate between open and closed positions.

The main body 102 comprises a first wireless module 107 as a power supply circuit that outputs a frequency signal corresponding to a transmission signal to transmit/receive radio waves through the first wireless communication antenna 104. The main body 102 further comprises a second wireless module 108 as a power supply circuit that outputs a frequency signal corresponding to a transmission signal to transmit/receive radio waves through the second wireless communication antenna 105.

According to a display signal (LVDS signal) received from a graphics processing unit (GPU) 205, the LCD panel 103 displays information or the like, and also drives the internal circuit with the pixel clock (operation frequency) of the display signal.

It is assumed herein that the first wireless module 107 and the second wireless module 108 perform communication in different communication bands. For example, the first wireless module 107 may be a communication module to connect to GPS, while the second wireless module 108 may be a communication module to connect to a wireless LAN. The GPS and wireless LAN are cited above as examples without limitation, and the first wireless module 107 and the second wireless module 108 may be communication modules to connect to, for example, Bluetooth (registered trademark), 3G, and the like.

The first wireless module 107 is connected to the first wireless communication antenna 104 via a power supply line 109. Similarly, the second wireless module 108 is connected to the second wireless communication antenna 105 via a power supply line 110. The power supply line 109 and the power supply line 110 are each a coaxial cable with a diameter of about 1 mm.

As described above, the first wireless communication antenna 104 and the second wireless communication antenna 105 are embedded in the display module 101 of the notebook PC 100 at locations close to the LCD panel 103. Therefore, if the communication frequency bands used for communication through the first wireless communication antenna 104 and the second wireless communication antenna 105 include the higher harmonics of the operation frequency of the LCD panel 103, interference occurs. In other words, the communication sensitivity of each wireless module is likely to be affected by the operation frequency of the LCD panel 103.

Incidentally, the communication frequency band used for wireless communication is defined in advance by a standard or the like. Thus, the communication frequency band for wireless communication cannot be changed. Accordingly, to prevent the occurrence of interference, the operation frequency of the LCD panel 103 is adjusted so that the communication frequency band for wireless communication does not include the higher harmonics of the operation frequency of the LCD panel 103. The higher harmonic refers herein to a high-order frequency component that is an integral multiple of the operation frequency.

The operation frequency of the LCD panel 103 is limited to reproduce video and the like. This is because the operation frequency is defined by a display standard such as video electronics standards association (VESA), and also a frequency of 60 Hz is supposed to be used to reproduce video content and reproduction quality decreases due to frame drop or the like with other refresh rates.

Therefore, according to the embodiment, the notebook PC 100 is provided with a plurality of pieces of extended display identification data (EDID) (pieces of display timing information), in which an operation frequency of the LCD panel 103 is associated with a display timing including setting information to perform display control at the operation frequency. A piece of the display timing information is selectively used according to the wireless module in operation so that the higher harmonics of a display signal do not interfere with wireless reception. Thus, the effect of the interference is reduced, and thereby the communication sensitivity can be improved. Naturally, in the display timing information, the horizontal frequency (refresh rate) is set to a value that satisfies the above standard.

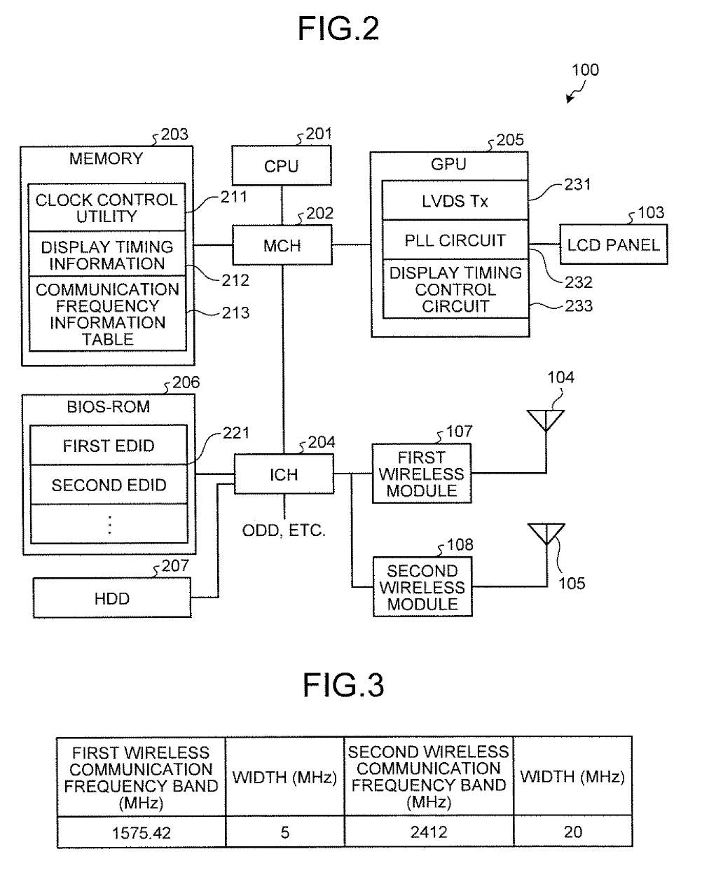

A description will now be given of a hardware configuration of the notebook PC 100 of the embodiment. As illustrated in FIG. 2, the notebook PC 100 comprises a CPU 201, a memory control hub (MCH) 202, a memory 203, an I/O controller hub (ICH) 204, the GPO 205, a BIOS-ROM 206, a hard disk drive (HOD) 207, the LCD panel 103, the first wireless module 107, the first wireless communication antenna 104, the second wireless module 108, and the second wireless communication antenna 105. Although not illustrated, the ICH 204 is connected to various devices such as an ODD.

The CPU 201 controls the operation of the notebook PC 100, and executes an operating system (OS) loaded from the HOD 207 into the memory 203. The CPU 201 also executes a system basic input-output system (BIOS) stored in the BIOS-ROM 206. The system BIOS is a program for hardware control.

In addition to the system BIOS, the BIOS-ROM 206 stores a plurality of pieces of EDID 221 including first EDID, second EDID, The EDID 221 are loaded into the memory 203 if necessary. Incidentally, each piece of the EDID 221 describes a display mode corresponding to the LCD panel 103.

The MCH 202 is a bridge that connects between the local bus of the CPU 201 and the ICH 204. The MCH 202 comprises a built-in memory controller that controls access to the memory 203. The MCH 202 has the function of communicating with the CPU 205 through an accelerated graphics port (ACP) bus, a PCI Express serial bus, or the like.

The GPU 205 is a display controller that controls the LCD panel 103 used as a display monitor of the notebook PC 100 of the embodiment. The GPU 205 sends a display signal representing display information generated by the OS or an application program to the LCD panel 103.

The GPU 205 comprises a built-in low-voltage differential signaling transmitter (LVDS Tx) 231. The LVDS Tx 231 is provided with a phase locked loop (PLL) circuit 232 and a display timing control circuit 233, and generates a display control signal for the LCD panel 103.

The PLL circuit 232 is capable of generating an arbitrary pixel clock (operation frequency). For example, if the PLL circuit 232 operates at a frequency of 68.5 MHz, the LVDS Tx 231 outputs a signal at a frequency of 68.5 MHz to the LCD panel 103. Further, upon receipt of a request to change the operation frequency, the PLL circuit 232 is capable of changing a frequency at which the LVDS Tx 231 operates.

The display timing control circuit 233 generates a display signal according to display timing information received from a display driver 403, which will be described later. Incidentally, a plurality of pieces of display timing information are stored in advance in the BIOS-ROM 206 as the EDID 221.

After the notebook PC 100 is turned on, the memory 203 stores a clock control utility 211, display timing information 212, and a communication frequency information table 213. The clock control utility 211 and the communication frequency information table 213 are read from the HOD 207 and loaded into the memory 203 after the OS is executed. Meanwhile, the display timing information 212 is read from the EDID 221 in the BIOS-ROM 206 and loaded into the memory 203.

The ICH 204 controls each device on a low pin count (LPC) bus as well as each device connected to a peripheral component interconnect (PCI) bus. The ICH 204 comprises a built-in integrated device electronics (IDE) controller to control the HOD 207.

The first wireless module 107 and the second wireless module 108 each are a module that performs wireless communication. FIG. 3 is a schematic diagram for explaining a frequency band management table that stores a communication frequency band for the first wireless module 107 and the second wireless module 108. As illustrated in FIG. 3, the first wireless module 107 uses a frequency bandwidth of (±) 5 MHz centered on 1575.42 MHz as a reference frequency. Meanwhile, the second wireless module 108 uses a frequency bandwidth of (±) 20 MHz centered on 2412 MHz as a reference frequency. If the higher harmonics of the operation frequency of the LCD panel 103 interfere with the communication frequency bands, the communication sensitivity decreases. A description will then be given of a software configuration of the notebook PC 100 to change the operation frequency not to interfere with the communication frequency bands.

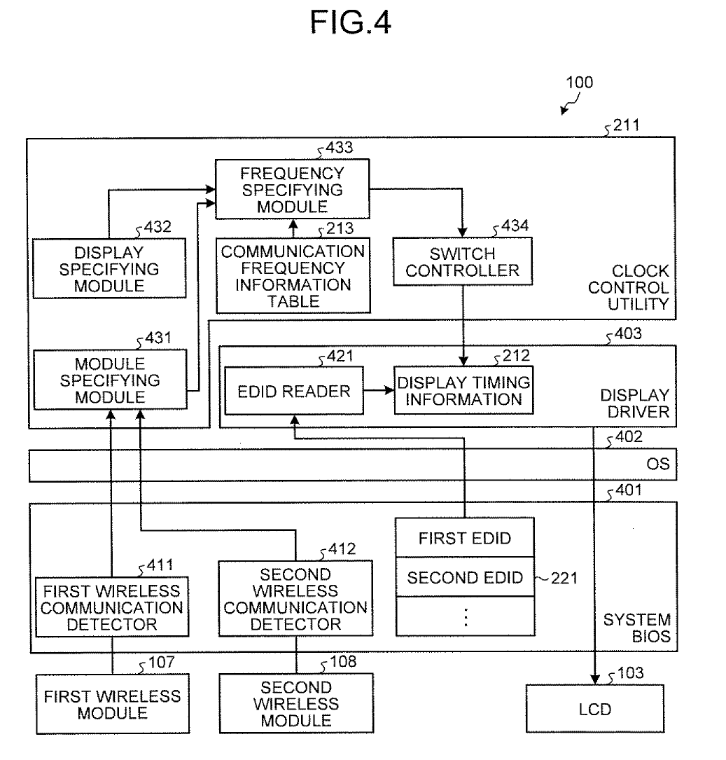

FIG. 4 is a block diagram of the software configuration of the notebook PC 100. As illustrated in FIG. 4, the notebook PC 100 comprises a system BIOS 401, an OS 402, the display driver 403, and the clock control utility 211. The system BIOS 401 controls hardware devices such as the LCD panel 103, the first wireless module 107, and the second wireless module 108.

The system BIOS 401 comprises a first wireless communication detector 411, a second wireless communication detector 412, and the EDID 221. The system BIOS 401 controls hardware devices according to an instruction from software such as the OS 402.

The first wireless communication detector 411 detects whether the first wireless module 107 is performing wireless communication. The first wireless communication detector 411 then outputs the detection result to a module specifying module 431 of the clock control utility 211.

The second wireless communication detector 412 detects whether the second wireless module 108 is performing wireless communication. The second wireless communication detector 412 then outputs the detection result to the module specifying module 431 of the clock control utility 211.

The pieces of the EDID 221 are switched according to the state of wireless communication.

The OS 402 executes software such as, for example, the clock control utility 211 and the display driver 403. The OS 402 provides hardware resources to the executed software.

The clock control utility 211 comprises the module specifying module 431, a display specifying module 432, a frequency specifying module 433, the communication frequency information table 213, and a switch controller 434. The clock control utility 211 is a utility program to control the operation frequency of the LCD panel 103 according to the state of wireless communication.

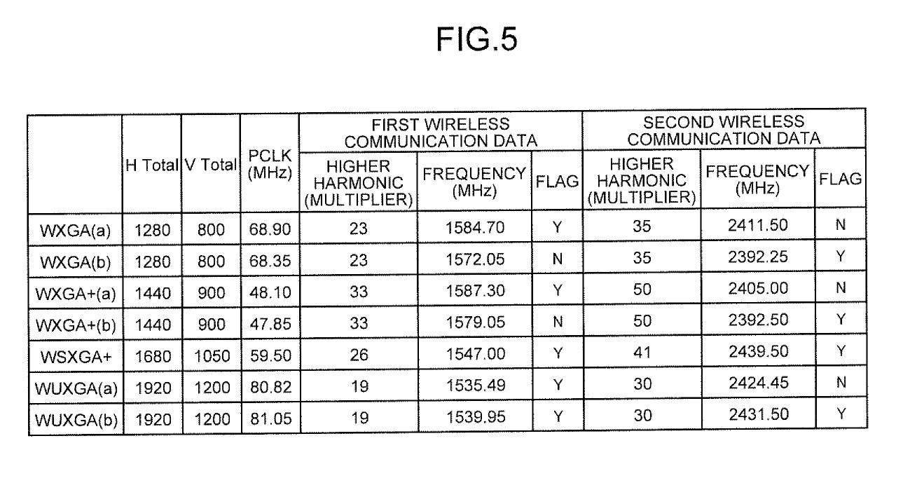

The communication frequency information table 213 stores an operation frequency (pixel clock) in association with a higher harmonic close to a communication frequency band used for wireless communication with respect to each resolution. FIG. 5 illustrates an example of the table structure of the communication frequency information table 213. As illustrated in FIG. 5, the communication frequency information table 213 stores the number of horizontal pixels (H total), the number of vertical pixels (V total), an operation frequency (MHz) or a pixel clock (POLK), first wireless communication data, and second wireless communication data in association with one another with respect to each resolution.

In FIG. 5. the number of horizontal pixels (H total) refers to the number of pixels in the horizontal direction with respect to each resolution. Similarly, the number of vertical pixels (V total) refers to the number of pixels in the vertical direction with respect to each resolution. The pixel clock (PCLK) refers to an operation frequency (MHz) to perform display control at each resolution.

As can be seen from FIG. 5, the first wireless communication data includes a higher harmonic (multiplier), a frequency (MHz), and a flag with respect to each resolution. As the “higher harmonic” of the first wireless communication data is stored a multiplier by which the operation frequency is multiplied so that the operation frequency is included in or most approximated to the communication frequency band of the first wireless module 107. As the “frequency” of the first wireless communication data is stored a frequency obtained by multiplying the operation frequency by the higher harmonic (multiplier). The “flag” indicates whether the frequency is included in (interferes with) the communication frequency band of the first wireless module 107. That is, an operation frequency can be selected that does not interfere with the first wireless module 107 by selecting the one with the flag indicating “Y” in the first wireless communication data. In other words, an operation frequency with the flag indicating “N” is included in (interferes with) the communication frequency band of the first wireless module 107.

Besides, the second wireless communication data includes a higher harmonic (multiplier), a frequency (MHz), and a flag with respect to each resolution. As the “higher harmonic” of the second wireless communication data is stored a multiplier by which the operation frequency is multiplied so that the operation frequency is included in or most approximated to the communication frequency band of the second wireless module 108. As the “frequency” of the second wireless communication data is stored a frequency obtained by multiplying the operation frequency by the higher harmonic (multiplier). The “flag” indicates that the frequency is included in (interferes with) the communication frequency band of the second wireless module 108. That is, an operation frequency can be selected that does not interfere with the second wireless module 108 by selecting the one with the flag indicating “Y” in the second wireless communication data. In other words, an operation frequency with the flag indicating “N” is included in (interferes with) the communication frequency band of the second wireless module 108.

In the example of FIG. 5, when the resolution of the LCD panel 103 is WSXGA+(1680×105), the higher harmonics of PCLK do not interfere with both the first wireless module 107 and the second wireless module 108. Accordingly, the operation frequency of 59.50 MHz does not cause any problem.

When the resolution of the LCD panel 103 is WUXGA (1920×1200), the higher harmonic of PCLK may interfere with the second wireless module 108 at the timing of WUXGA(a). However, the higher harmonics of PCLK do not interfere with both the first wireless module 107 and the second wireless module 108 at the timing of WUXGA(b). Therefore, the timing of WUXGA(b) can be used.

When the resolution of the LCD panel 103 is WXGA (1280×800), the higher harmonic of PCLK may interfere with the second wireless module 108 at the timing of WXGA(a). In addition, the higher harmonic of PCLK may interfere with the first wireless module 107 at the timing of WXGA(b). Since the flag of the first wireless communication data indicates “Y” for WXGA(a), the timing of WXGA(a) is set to be used only when the first wireless module 107 is in use. On the other hand, since the flag of the second wireless communication data indicates “Y” for WXGA(b), the timing of WXGA(b) is set to be used only when the second wireless module 108 is in use.

Note that, even if the notebook PC 100 comprises three types or more of wireless modules, display timings may be set in the manner as described above for each of the modules and selectively used to prevent interference with the wireless communication frequency band.

The module specifying module 431 specifies a wireless module that is currently performing wireless communication from among the plurality of wireless modules. The module specifying module 431 of the embodiment specifies a wireless module that is currently performing wireless communication based on the detection results received from the first wireless communication detector 411 and the second wireless communication detector 412. The module specifying module 431 outputs information that identifies the specified wireless module that is currently performing wireless communication to the frequency specifying module 433.

The display specifying module 432 specifies a resolution that can be displayed on the LCD panel 103. Further, upon receipt of an instruction to change the resolution of the LCD panel 103 from the user or the OS 402, the display specifying module 432 changes the resolution.

The frequency specifying module 433 specifies, from those stored in the communication frequency information table 213, an operation frequency no integer multiple of which is included in the communication frequency band of the wireless module specified by the module specifying module 431. At this time, the frequency specifying module 433 specifies, as the operation frequency, an operation frequency that is associated with a resolution specified by the display specifying module 432 in the communication frequency information table 213.

In other words, the frequency specifying module 433 of the embodiment specifies a pixel clock PCLK (MHz) with the flag indicating “Y” for the wireless module specified by the module specifying module 431 from among the records of the resolution specified by the display specifying module 432.

Referring back to FIG. 4, the switch controller 434 issues an instruction to the display driver 403 to control the display of the LCD panel 103, i.e., to switch the resolution and operation frequency of the LCD panel 103, based on the operation frequency specified by the frequency specifying module 433 and the resolution specified by the display specifying module 432.

The display driver 403 comprises an EDID reader 421. Upon receipt of the instruction from the switch controller 434, the display driver 403 controls the display of the LCD panel 103 based on the resolution and the operation frequency instructed by the switch controller 434. That is, the display driver 403 instructs the display timing control circuit 233 (see FIG. 2) to operate according display timing information corresponding to the resolution and the operation frequency (pixel clock).

The EDID reader 421 reads a piece of the EDID 221 necessary for display control based on the resolution and the operation frequency (pixel clock) instructed by the switch controller 434 from the system BIOS 401. The EDID reader 421 then loads the EDID 221 into the memory 203 as the display timing information 212.

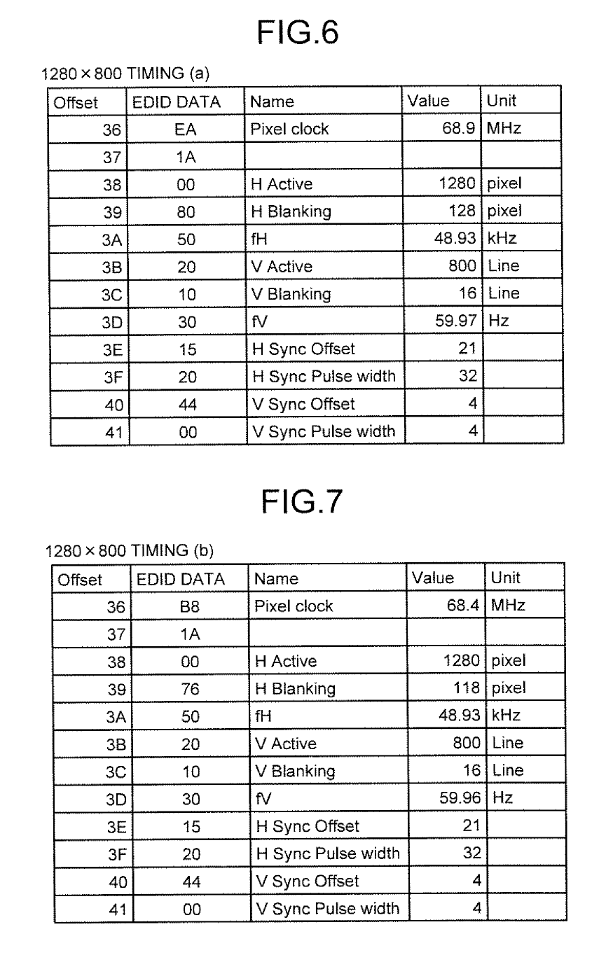

FIGS. 6 and 7 illustrate examples of the display timing information, i.e., 1280×800 timing (a) and 1280×800 timing (b), respectively. As can be seen from FIGS. 6 and 7, the display timing information includes items such as “Pixel clock”, “H Active”, “H Blanking”, “fH”, “V Active”, “V Blanking”, “fV”, “H Sync Offset”, “H Sync Pulse width”, “V Sync Offset”, and “V Sync Pulse width”, which are associated with one another. In other words, as the display timing information, the operation frequency “Pixel clock” is stored in association with setting information used to perform display control according to a display signal.

The display timing illustrated in FIG. 6 represents the display timing of WXGA(a). The display timing is a de facto standard for the LCD panel 103 with this resolution and is a standard timing. On the other hand, the display timing illustrated in FIG. 7 is a timing in which parameters are adjusted to avoid interference by higher harmonics.

Although FIGS. 6 and 7 both illustrate the display timing information with a resolution of 1280x800, in addition to the operation frequency “Pixel clock”, some parameters may be different. It is assumed herein that the parameters “H Blanking”, “fH”, “V Blanking”, and “fV” may be different.

The operation frequency “Pixel clock” indicating the operation frequency refers herein to the number of pixels rendered per second. For example, if the pixel clock is 68.9 MHz, 680900000 pixels can be rendered.

The parameter “H Active” (horizontal active period) refers herein to a period (the number of pixels) in which a horizontal line of video is rendered. On the other hand, “H Blanking” (horizontal blanking period) refers herein to a blanking period (the number of pixels) in which display processing is not performed for a horizontal line.

The parameter “fH” (horizontal frequency) refers herein to the number of (horizontal) lines rendered per second.

More specifically, “fH” (horizontal frequency) is expressed by Equation (1) as follows:

fH=Pixel clock÷(H Active+H Blanking) (1)

The parameter “V Active” (vertical active period) refers herein to a period (the number of (horizontal) lines) in which a (vertical) frame of video is rendered. On the other hand, “V Blanking” (vertical blanking period) refers herein to a blanking period (the number of (horizontal) lines) in which display processing is not performed for a (vertical) frame.

The parameter “fV” (vertical frequency) refers herein to the number of frames rendered per second.

More specifically, “fV” (vertical frequency) is expressed by Equation (2) as follows:

fV=fH÷(V Active+V Blanking) (2)

Incidentally, if, for example, the pixel clock frequency is simply set to 68.35 (68.4) MHz to avoid interference by higher harmonics according to the conventional technology, then, the operation frequency (refresh rate) is 59.53 Hz.

However, a refresh rate of 60 Hz is generally used to display video content on DVD, TV, and the like. If the refresh rate decreases, a frame drop occurs. In this example, the frame drop occurs 0.47 per second, i.e., once for about two seconds. This results in the degradation of video quality. Accordingly, it is preferable that the refresh rate be set within the range of about 59.9 Hz to 60.1 Hz.

Further, games operated on a PC often requires a frequency higher than 60 Hz. For this reason, it is preferable that the refresh rate, i.e., “fV” (vertical frequency), be equal to or higher than 59.9 Hz.

That is, the higher harmonic of the operation frequency “Pixel clock” needs to be controlled such that it is not included in the communication frequency band of a wireless module that is currently performing communication under the condition where “fV” (vertical frequency) is set to the above value. Further, the relations expressed by Equations (1) and (2) need to be satisfied. Among the parameters expressed by Equations (1) and (2), however, there is one that is not variable.

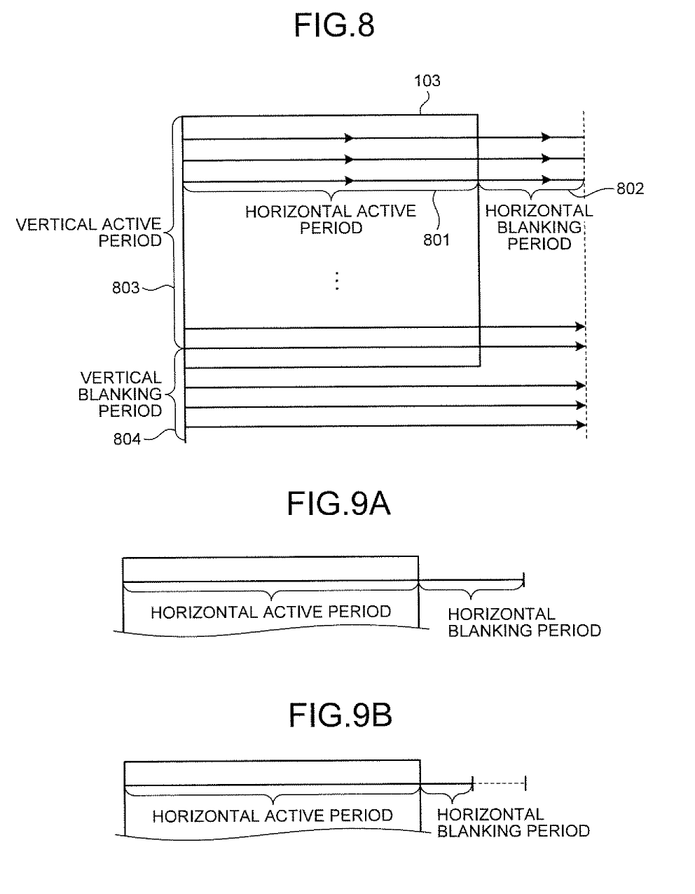

Described below is variable parameters. First, a description will be given of the relationship among the parameters “H Active” (horizontal active period), “H Blanking” (horizontal blanking period), “V Active” (vertical active period), and “V Blanking” (vertical blanking period). FIG. 8 is a conceptual diagram for explaining the relationship among these parameters. As illustrated in FIG. 8, a horizontal active period 801 refers to a period (the number of pixels) in which a horizontal line of the LCD panel 103 is rendered. For example, when the LCD panel 103 has a resolution of 1280×800 pixels, the horizontal active period 801 is fixed to 1280 pixels, and cannot be changed. On the other hand, a horizontal blanking period 802 refers to a period for preparation to render the next horizontal line. The horizontal blanking period 802 can be changed to some extent if necessary.

Meanwhile, a vertical active period 803 refers to a period (the number of lines) in which a frame of the LCD panel 103 is rendered. For example, when the LCD panel 103 has a resolution of 1280×800 pixels, the vertical active period 803 is fixed to 800 lines, and cannot be changed. On the other hand, a vertical blanking period 804 refers to a period for preparation to render the next frame. The vertical blanking period 804 can be changed to some extent if necessary.

FIGS. 9A and 9B are conceptual diagrams for explaining the adjustment of the horizontal blanking period. As illustrated in FIGS. 9A and 9B, in the embodiment, the horizontal blanking period illustrated in FIG. 9A is adjusted to that illustrated in FIG. 9B so that the operation frequency is not included in the communication frequency band of the wireless module and the value of “fV” (vertical frequency) is higher than 59.9 Hz and close to 60 Hz. The vertical blanking period can be adjusted in the same manner as described above.

In this manner, according to the embodiment, the horizontal blanking period and the vertical blanking period are adjusted. Thus, it is possible to provide the display timing information in which are set a vertical frequency that enables the reproduction of video data, etc. and an operation frequency the higher harmonic of which is not included in the communication frequency band of the wireless module.

Further, according to the embodiment, the display timing information is prepared with respect to each resolution to perform display control in such a manner as to avoid interference when wireless communication is performed by anyone of the first wireless module 107 and the second wireless module 108.

The display timing information can be generated in the manner as described above, and the detailed description will not be given here. The generated display timing information is stored in advance in the BIOS-ROM 206 as EDID, and the EDID reader 421 reads the EDID as required.

With this, if any resolution is specified by the user, display control can be performed for the LCD panel 103 without interference with the wireless module.

Referring back to FIGS. 6 and 7, “H Sync Offset” (horizontal synchronization offset), “H Sync Pulse width” (horizontal synchronization pulse width), “V Sync Offset” (vertical synchronization offset), and “V Sync Pulse width” (vertical synchronization pulse width) are also parameters used for display control.

Referring back to FIG. 4, the display driver 403 specifies display timing information to apply based on a resolution and an operation frequency (pixel clock) received form the switch controller 434. The display driver 403 instructs the display timing control circuit 233 to control the display of the LCD panel 103 according to the specified display timing information. Thus, the display driver 403 can output a display signal at the operation frequency that corresponds to a vertical frequency enabling the reproduction of video or a game and that does not interfere with the wireless module that is currently performing communication.

While, in the embodiment, the setting information used for display control is described as including parameters “H Active”, “H Blanking”, “fH”, “V Active”, “V Blanking”, “fV”, “H Sync Offset”, “H Sync Pulse width”, “V Sync Offset”, and “V Sync Pulse width”, it may include any other parameters.

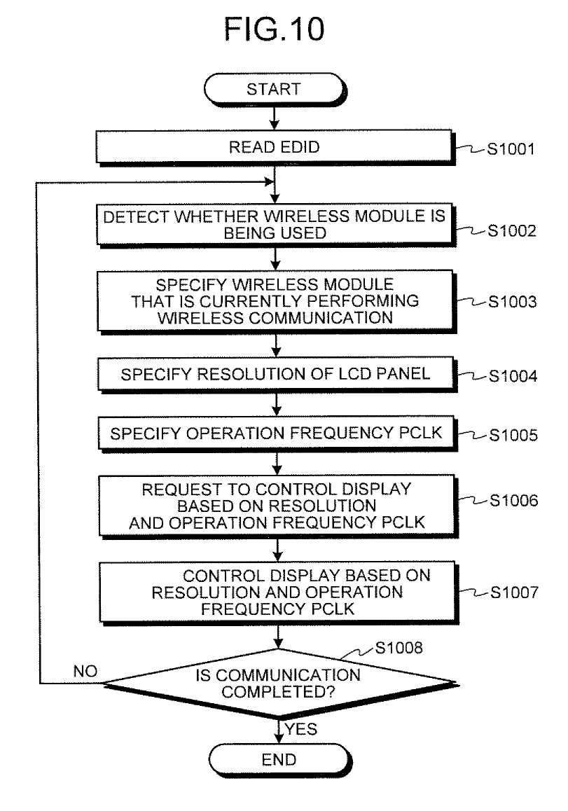

A description will now be given of the process of controlling display on the LCD panel 103 of the notebook PC 100 according to the embodiment. FIG. 10 is a flowchart of the above process performed by the notebook PC 100.

First, after the notebook PC 100 is turned on, the CPU 201 reads the OS 402, the display driver 403, and the clock control utility 211, and executes them. At this time, the communication frequency information table 213 is also loaded into the memory 203.

Then, the EDID reader 421 of the display driver 403 reads the EDID 221 and loads it into the memory 203 as the display timing information (S1001). After that, when the user uses the notebook PC 100, wireless communication starts.

Thereafter, the first wireless communication detector 411 and the second wireless communication detector 412 detect whether respective wireless modules are performing wireless communication (S1002).

According to the detection results received from the first wireless communication detector 411 and the second wireless communication detector 412, the module specifying module 431 specifies a wireless module that is currently performing wireless communication (S1003).

Subsequently, the display specifying module 432 specifies a resolution for the LCD panel 103 (S1004).

The frequency specifying module 433 specifies an operation frequency (POLK) based on the wireless module specified at 51003 and the resolution specified at 51004 (S1005). The frequency specifying module 433 of the embodiment specifies an operation frequency to control display with the specified resolution, the higher harmonic of which is not included in the communication frequency band of the specified wireless module.

After that, the switch controller 434 requests the display driver 403 to control the display of the LCD panel 103 based on the specified resolution and the specified operation frequency (S1006).

In response to the request, the display driver 403 perform display control for the LCD panel 103 based on display timing information corresponding to the specified resolution and the specified operation frequency (S1007). Incidentally, if there is no appropriate display timing information, the EDID reader 421 reads necessary EDID again.

Thereafter, the clock control utility 211 determines whether the notebook PC 100 completes the communication (S1008). When the clock control utility 211 determines that the notebook PC 100 does not complete the communication (No at S1008), the process returns to 51002. On the other hand, when the clock control utility 211 determines that the notebook PC 100 completes the communication (Yes at S1008), the process ends.

While, in the embodiment, the wireless modules are described as communication modules to connect to a wireless LAN and GPS, respectively, this is by way of example only. The wireless modules may be other communication modules to connect to, for example, Bluetooth (registered trademark), WiFi, and the like.

Although the notebook PC 100 is described above as being provided with two wireless modules, the number of wireless modules is not limited to two. The notebook PC 100 may be provided with three or more wireless modules. The number of modules to be mounted on the notebook PC 100 may be selected by the user with, for example, build-to-order (BTO) options. In this case, display timing information is stored in advance such that all wireless modules mounted on the notebook PC 100 has appropriate communication sensitivity.

As described above, according to the embodiment, the EDID 221 including an operation frequency (pixel clock) and blanking periods each adjusted in advance are stored in the BIOS-ROM 206 for display control. Thus, display control can be performed for the LCD panel 103 with the display timing not to interfere with the communication frequency band of a wireless module in operation.

Moreover, the display timing to control the LCD panel 103 of the notebook PC 100 is adjusted such that the display refresh rate (vertical frequency) is about 60 Hz regardless of the difference in pixel clock and resolution. With this, it is possible to prevent frame drop during the reproduction of video, the unavailability of a game, and the like.

If display control is performed for the LCD panel 103 with a display refresh rate (vertical frequency) of 60 Hz, the output timing to output a signal to the LCD panel 103 can be shifted from the timing of a pixel clock. Thus, it is possible to reduce interference between the operation frequency and the communication frequency.

Furthermore, even if the built-in LCD panel 103 has a limitation that the refresh rate has to be set to 60 Hz, by shifting its operation frequency, it is possible to reduce interference with the reception frequency of a wireless module mounted on the notebook PC 100, and thereby to improve the communication sensitivity of the wireless module.

Differently from the conventional technology in which interference is reduced by simply shifting the pixel clock, according to the embodiment, a display timing table is created in which the blanking periods are adjusted so that the vertical frequency is equal to or higher than 59.9 Hz. With this, it is possible to improve the communication sensitivity as well as to prevent the degradation of video quality.

In other words, differently from the conventional technology in which interference is reduced by simply shifting the operation frequency, according to the embodiment, the display timing table is stored in which the pixel clock and the blanking periods are adjusted while the refresh rate is maintained around 60 Hz that is unique to the LCD panel 103. Thus, it is possible to improve the communication sensitivity as well as to prevent the degradation of video quality.

The display control of the embodiment may be implemented by executing a computer program (hereinafter, “display control program”) on the notebook PC 100. The display control program may be provided as being stored in a computer-readable storage medium, such as a compact disk read-only memory (CD-ROM), a flexible disk (FD), a compact disc-recordable (CD-R), or a digital versatile disc (DVD), in an installable or executable format.

The display control program executed on the notebook PC 100 of the embodiment may also be stored in a computer connected via a network such as the Internet so that it can be downloaded therefrom. The display control program may also be provided or distributed via a network such as the Internet.

The display control program executed on the notebook PC 100 of the embodiment may be provided as being stored in advance in ROM or the like.

The display control program executed on the notebook PC 100 of the embodiment includes modules that implement the clock control utility 211 (the module specifying module 431, the display specifying module 432, the frequency specifying module 433, and the switch controller 434) and the display driver 403. As hardware, the CPU 201 loads the display control program from the storage medium described above into the memory 203 and executes it . Thus, the clock control utility 211 (the module specifying module 431, the display specifying module 432, the frequency specifying module 433, and the switch controller 434) and the display driver 403 are implemented on the memory 203.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a plurality of wireless communication modules configured to use different communication frequency bands;
a storage module configured to store operation frequencies to control display of a display module and pieces of setting information, each of the operation frequencies being associated with a piece of the setting information to control the display of the display module based on the operation frequency;
a communication module specifying module configured to specify, from the wireless communication modules, a wireless communication module that is performing communication;
a frequency specifying module configured to specify, from the operation frequencies stored in the storage module, an operation frequency no integer multiple of which is included in a communication frequency band of the wireless communication module specified by the communication module specifying module; and
a controller configured to control the display of the display module based on a piece of the setting information associated with the operation frequency specified by the frequency specifying module.

2. The electronic device of claim 1, further comprising a display specifying module configured to specify a resolution displayable by the display module, wherein
the storage module is configured to further store resolutions of the display module each in association with one of the operation frequencies and a piece of the setting information,
the frequency specifying module is configured to specify, from operation frequencies associated with the resolution specified by the display specifying module, the operation frequency no integer multiple of which is included in the communication frequency band of the wireless communication module, and
the controller is configured to control the display of the display module based further on the resolution specified by the display specifying module.

3. The electronic device of claim 2, wherein the operation frequencies stored in the storage module include
a first operation frequency associated with a predetermined resolution, no integer multiple of which is included in a communication frequency band of one of the wireless communication modules, and
a second operation frequency associated with the predetermined resolution, no integer multiple of which is included in a communication frequency band of another one of the wireless communication modules.

4. The electronic device of claim 3, wherein at least one of a horizontal blanking period and a vertical blanking period is different between a piece of the setting information associated with the first operation frequency and a piece of the setting information associated with the second operation frequency.

5. The electronic device of claim 1, wherein all vertical frequencies included in the setting information stored in the storage module are higher than 59.9 hertz.

6. The electronic device of claim 1, wherein the setting information stored in the storage module includes at least one of a horizontal frequency, a horizontal active period, a horizontal blanking period, a vertical frequency, a vertical active period, and a vertical blanking period.

7. A display control method applied to an electronic device comprising a storage module configured to store operation frequencies to control display of a display module and pieces of setting information, each of the operation frequencies being associated with a piece of the setting information to control the display of the display module based on the operation frequency, the display control method comprising:
a communication module specifying module specifying, from a plurality of wireless communication modules configured to use different communication frequency bands, a wireless communication module that is performing communication;
a frequency specifying module specifying, from the operation frequencies stored in the storage module, an operation frequency no integer multiple of which is included in a communication frequency band of the wireless communication module specified by the communication module specifying module; and
a controller controlling the display of the display module based on a piece of the setting information associated with the operation frequency specified by the frequency specifying module.

8. The display control method of claim 7, further comprising a display specifying module specifying a resolution displayable by the display module, wherein
the storage module further storing resolutions of the display module each in association with one of the operation frequencies and a piece of the setting information,
the frequency specifying module specifying, from operation frequencies associated with the resolution specified by the display specifying module, the operation frequency no integer multiple of which is included in the communication frequency band of the wireless communication module, and
the controller controlling the display of the display module based further on the resolution specified by the display specifying module.

9. The display control method of claim 7, wherein all vertical frequencies included in the setting information stored in the storage module are higher than 59.9 hertz.
